(19) United States
(12) Patent Application Publication
(10) Pub. No.: US 2014/0210198 A1
(43) Pub. Date: Jul. 31, 2014

(54) Rotating Shrink Label With Stationary Shrink Base Label

(71) Applicant: Stephen M. Key, Modesto, CA (US)

(72) Inventor: Stephen M. Key, Modesto, CA (US)

(21) Appl. No.: 14/166,812

(22) Filed: Jan. 28, 2014

Related U.S. Application Data
(60) Provisional application No. 61/758,060, filed on Jan. 29, 2013.
(60) Provisional application No. 61/822,648, filed on May 13, 2013.

(51) Int. Cl. B42D 15/00

(52) U.S. Cl. CPC B42D 15/0073
USPC 283/70; 283/81

(57) ABSTRACT

The present application is directed to dual rotating shrink label systems for a container with non-parallel. A base label may be shrunk to non-rotatably conform to the non-parallel sides of the container. A rotating top label may be shrunk to conform over the base label. The rotating top label may have one or more transparent windows displaying printed information on the base label.

### CROSS-REFERENCE TO RELATED APPLICATIONS

The present application claims priority to provisional U.S. Patent Application Ser. No. 61/758,060, filed on Jan. 29, 2013, titled “Rotating Shrink Top Label with Stationary Shrink Base Label” and provisional U.S. Patent Application Ser. No. 61/822,648, filed on May 13, 2013, titled “Rotating Shrink Top Label with Stationary Shrink Base Label Including Tamper Evident Band,” which are hereby incorporated by reference in their entirety.

### FIELD OF THE INVENTION

The present application is directed generally to labels, and more specifically to shrink labels for consumer product containers that conform and rotate about non-parallel sides of the container.

### BACKGROUND

Containers for consumer products have a limited amount of outer surface area for placement of labels on the container. This may pose a challenge to manufacturers of these consumer products to fit all of the information they want to deliver to the consumer, or are required by law to deliver to the consumer, in this limited area. In particular, packaging for prescription medications may be required to specify a significant amount of information concerning dosage, frequency of consumption, warnings, drug facts, and repetition of this information in more than one language.

In order to deliver all the information the manufacturer deems necessary to the consumer, the manufacturer may resort to providing separate leaflets, cartons, and inserts containing the information. However, each additional piece increases the cost of the product. Manufacturers are also increasingly aware of the need to employ environmentally sustainable packaging and seek ways to decrease the need to provide additional printed material.

Many containers are designed and produced with a contoured shape comprising concave, convex, or other non-parallel surfaces where the labels are to be placed. Standard flat labels such as pressure sensitive, roll fed, or cut and stack labels cannot typically be affixed to these non-parallel surfaces without buckling, creasing, or tearing because they require a flat labeling surface.

Another concern with current label manufacturing is that it may be difficult to incorporate tamper evident features within the labeling and packaging. This may lead the manufacturer to use a shrink band, adhesive seal, or other mechanism that will make tampering evident. These measures increase costs even further and complicate sustainability issues.

### SUMMARY

The present application is directed to rotating shrink label systems for a container having non-parallel surfaces. An exemplary rotating shrink label system may comprise a base label comprising a material that shrinks when exposed to an energy source adhered to the non-parallel sides of the container. The base label may have a surface with printed information thereon. A rotating top label comprising a material that shrinks when exposed to an energy source may cover at least a portion of the base label. The rotating top label may comprise one or more transparent windows allowing at least a portion of the printed information to be visible through the windows.

According to additional exemplary embodiments, the present application may be directed to a rotating shrink label system for a container having non-parallel sides comprising a based label comprising a material that shrinks when exposed to an energy source. The base label may have printed information thereon. The base label may also comprise a first section positioned about an upper portion of the container, and a second section positioned about a lower portion of the container. The first and second sections may be coupled by a perforation. A rotating top label comprising a material that shrinks when exposed to an energy source may cover at least a portion of the base label. The top label may further comprise one or more transparent windows allowing at least a portion of the printed information to be visible through the transparent windows. Decoupling the first section of the top label from the second section may comprise a tamper evident feature and may allow the second section to rotate about the container.

According to still further exemplary embodiments, the present application may be directed to methods for delivering information on a container having non-parallel sides. An exemplary method may comprise providing a base label comprising a material that shrinks when exposed to an energy source, and displaying printed information on a surface of the base label. The base label may be positioned about the non-parallel surfaces of the container, then exposed to a heat source such that the base label shrinks and non-rotatably conforms to the non-parallel surfaces of the container. A top label comprising a material that shrinks when exposed to an energy source may be provided, and one or more transparent windows may be placed within a portion of the top label such that at least a portion of the printed information is displayed in the transparent windows. The top label may be positioned about the base label and the non-parallel sides of the container. The top label may be exposed to an energy source such that the top label shrinks and rotatably conforms to the non-parallel surfaces of the container.

### BRIEF DESCRIPTION OF THE DRAWINGS

FIG. 1 is a front view of an exemplary label according to various embodiments.

FIG. 2 is a back view of an exemplary label according to various embodiments.

FIG. 3 is a front view of an exemplary label according to various embodiments.

FIG. 4 is a back view of an exemplary label according to various embodiments.

FIG. 5A illustrates a leading edge of an exemplary label affixed to a container according to various embodiments.

FIG. 5B illustrates an exemplary label secured about a container according to various embodiments.

FIG. 6 illustrates an exemplary label secured about a container according to various embodiments.

FIG. 7 illustrates an exemplary base label secured about a container according to various embodiments.

FIG. 8 illustrates a leading edge of an exemplary top label affixed to an exemplary base label according to various embodiments.

FIG. 9 illustrates an exemplary top label affixed to an exemplary base label and partially wrapped about a container according to various embodiments.

FIG. 10 illustrates an exemplary top label with a window affixed to an exemplary base label and partially wrapped about a container according to various embodiments.

FIG. 11 illustrates an exemplary top label with a window secured about a container and a portion of a base label visible through the window according to various embodiments.

FIG. 12 is a front view of container having non-parallel sides according to various embodiments.

FIG. 13 is a front view of a base label according to various embodiments.

FIG. 14 is a back view of a base label according to various embodiments.

FIG. 15 a front perspective view of a base label formed into a cylinder according to various embodiments.

FIG. 16 is a front perspective view of a base label for covering a portion of the container and formed into a cylinder according to various embodiments.

FIG. 17 is a front view of a container with non-parallel sides and an adhesive strip applied to the sides according to various embodiments.

FIG. 18 is a front perspective view of the base label of FIG. 15 placed about a container prior to shrinking the base label according to various embodiments.

FIG. 19 is a front perspective view of the base label of FIG. 16 placed about a container prior to shrinking the base label according to various embodiments.

FIG. 20 is a front view of a container with the base label of FIG. 15 shrunk to conform to the non-parallel sides of the container according to various embodiments.

FIG. 21 is a front view of a container with the base label of FIG. 16 shrunk to conform to the non-parallel sides of the container according to various embodiments.

FIG. 22 is a front perspective view of a top label formed into a cylinder according to various embodiments.

FIG. 23 is a front perspective view of the top label of FIG. 22 placed about a container with a base label already shrunk to conform to the non-parallel sides according to various embodiments.

FIG. 24 is a front view of a top label shrunk to conform to a container and base label according to various embodiments.

FIG. 25 is a front view of a top label having a first and second section coupled by a perforation and the first section having a tamper evident feature according to various embodiments.

FIG. 26 is a front perspective view of the top label of FIG. 25 formed into a cylinder according to various embodiments.

FIG. 27 is a front perspective view of the top label of FIG. 26 with adhesive applied to a first section of the top label according to various embodiments.

FIG. 28 is a front view of a container with a base label in place and the top label of FIG. 26 shrunk to conform to the non-parallel sides of the container according to various embodiments.

FIG. 29 is a front view of the container and label system of FIG. 26 illustrating a tamper evident feature according to various embodiments.

FIG. 30 is a front view of the container and label system of FIG. 29 with the first section of the top label decoupled from the second section allowing the second section to rotate about the container according to various embodiments.

FIG. 31 is a front view of a base label having a first and second section coupled by a perforation and the first section having a tamper evident feature according to various embodiments.

FIG. 32 is a back view of the base label of FIG. 31 with an adhesive applied to the back surface according to various embodiments.

FIG. 33 is a front perspective view of the base label of FIG. 31 formed into a cylinder according to various embodiments.

FIG. 34 is a front view of a cylinder with the base label of FIG. 33 shrunk to conform to the non-parallel sides according to various embodiments.

FIG. 35 is a front view of the container and base label of FIG. 34 with a top label shrink to conform to the non-parallel sides according to various embodiments.

FIG. 36 is cross-sectional view of a base label according to various embodiments.

FIG. 37 is a cross-sectional view of a top label according to various embodiments.

FIG. 38 is an exemplary flow diagram of a method for delivering information associated with a container having non-parallel sides according to various embodiments.

### DETAILED DESCRIPTION

The present application is directed to rotating shrink label systems for a container having non-parallel surfaces. An exemplary rotating shrink label system may comprise a base label comprising a material that shrinks when exposed to an energy source adhered to the non-parallel sides of the container. The base label may have a surface with printed information thereon. A rotating top label comprising a material that shrinks when exposed to an energy source may cover at least a portion of the base label. The rotating top label may comprise one or more transparent windows allowing at least a portion of the printed information to be visible through the windows.

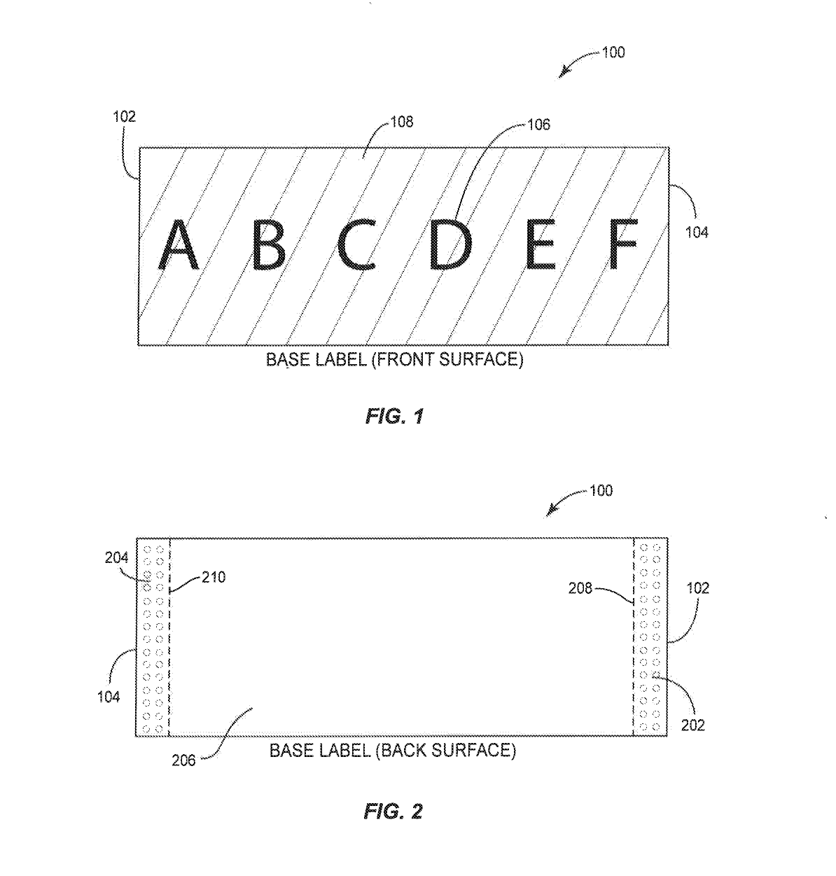

FIG. 1 illustrates various embodiments of a front surface 108 of a base label 100 for an object, such as a medication container, according to various embodiments. The base label 100 comprises a leading edge 102 and a trailing edge 104. While the leading edge 102 is oriented to the left and the trailing edge is oriented to the right as presented in FIG. 1, the orientation of the leading edge 102 and the trailing edge 104 could be reversed depending on which edge is first applied to the object. Both orientations are within the scope of the present disclosure. Base label front surface 108 may comprise writing or other indicia 106 thereon.

As used herein, the leading edge refers to the first edge to be affixed to the object and the trailing edge refers to the second edge to be affixed to the object or the overlapping leading edge. Depending on the orientation of the label and the object when the label is affixed to the object, either edge of the label may be the leading edge. The orientations presented in the figures are for convenience and are not intended to be limiting in any way.

FIG. 2 illustrates various embodiments of a back surface 206 of the base label 100. In various embodiments, the base label back surface 206 comprises two strips of adhesive 202 and 204 on or immediately adjacent to the leading and trailing edges, 102 and 104, respectively. Base label leading edge adhesive 202 may have a boundary 208 defined as its limit on the base label back surface 206. Base label trailing edge adhesive 204 may also have a boundary 210. While FIG. 2 illustrates that the adhesive strips 202 and 204 are generally close to the base label leading and trailing edges 102 and 104, respectively, it is understood that the adhesive strips 202 and 204 may be continuous or discontinuous, and may extend across any portion of the base label back surface 206, including the entire base label back surface 206. In various embodiments, a length of the base label 100 may be selected to be slightly longer than a circumference of the object on which it is placed, such that the trailing edge 104 overlaps the leading edge 102, and the trailing edge 104 is affixed to the leading edge 102. In various embodiments, the length of the base label 100 may be selected to be approximately the same as the circumference of the object on which it is placed, such that the leading edge 102 and the trailing edge 104 do not overlap.

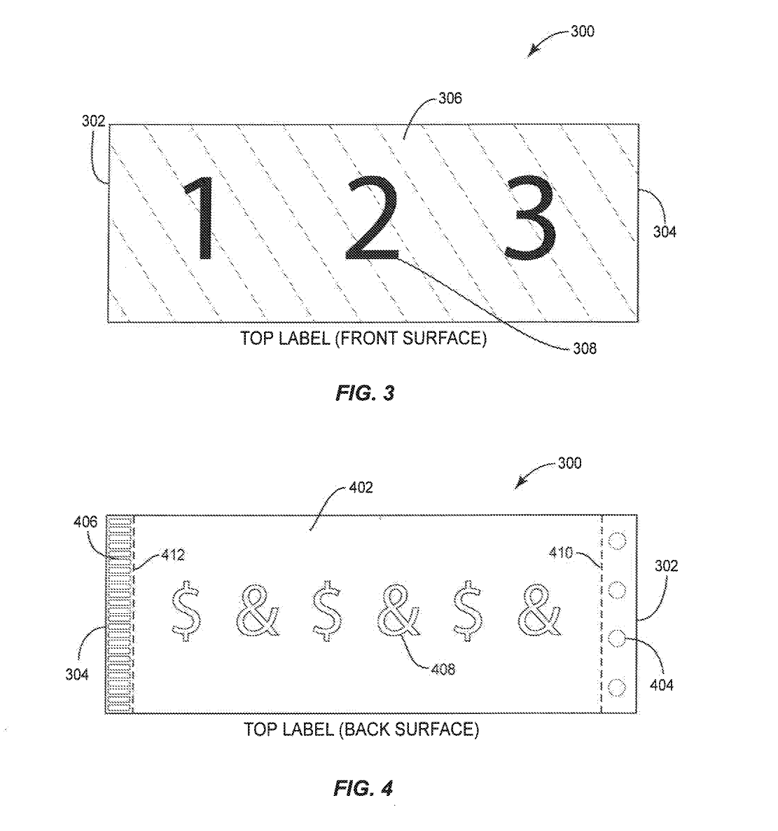

FIG. 3 illustrates various embodiments of a front surface 306 of a top label 300. Top label 300 comprises a leading edge 302 and a trailing edge 304, and indicia 308 may be imprinted on the top label front surface 306.

Various embodiments of a back surface 402 of the top label 300 are illustrated in FIG. 4. The top label back surface 402 may comprise various indicia 408 printed thereon, as well as two strips of adhesive 404 and 406 on or immediately adjacent to the leading and trailing edges, 302 and 304, respectively. Top label leading edge adhesive 404 may have a boundary 410 defined as its limit on the top label back surface 402. Top label trailing edge adhesive 406 may also have a boundary 412. While FIG. 4 illustrates that the adhesive strips 404 and 406 are generally close to the top label leading and trailing edges 302 and 304, respectively, it is understood that the adhesive strips 404 and 406 may be continuous or discontinuous, and may extend across any portion of the top label back surface 402, including the entire top label back surface 402. In various embodiments, the adhesive strips 404 and 406 are confined to areas near the leading and trailing edges 302 and 304, respectively, so as not to obscure or interfere with the top label back surface indicia 408.

The base label adhesive 202, 204 and the top label adhesive 404, 406 may be applied in a variety of patterns as can be appreciated by one skilled in the art. The adhesive 202, 204, 404, 406 may be applied in in strips, dots, droplets, circles, rectangles, squares, triangles, lines, and the like, as well as combinations of patterns.

A length of the top label 300 may be selected to be slightly longer than a circumference of the object on which it is placed, such that the top label trailing edge 304 overlaps the top label leading edge 302, and the top label trailing edge 304 is affixed to the top label leading edge 302. In various embodiments, the length of the top label 300 may be selected to be approximately the same as the circumference of the object on which it is placed, such that both the leading edge 302 and the trailing edge 304 do not overlap and are affixed to the base label front surface 108.

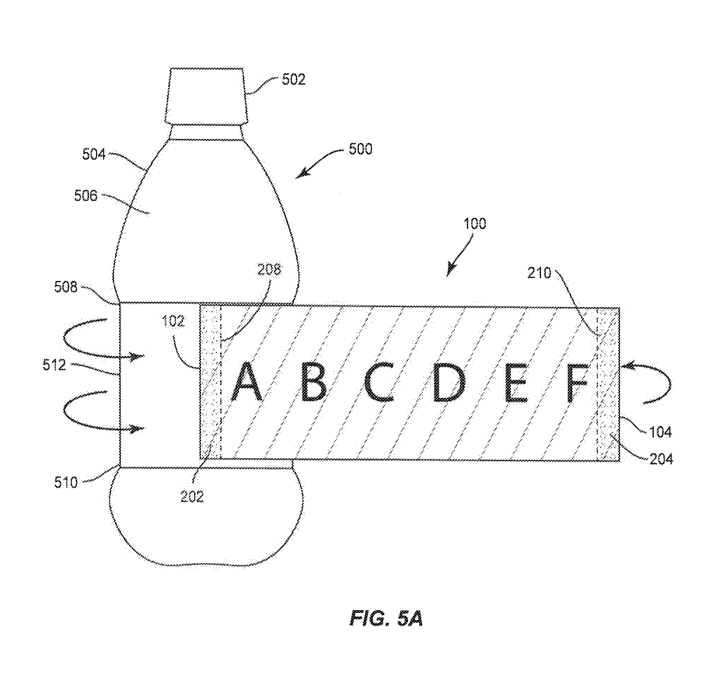

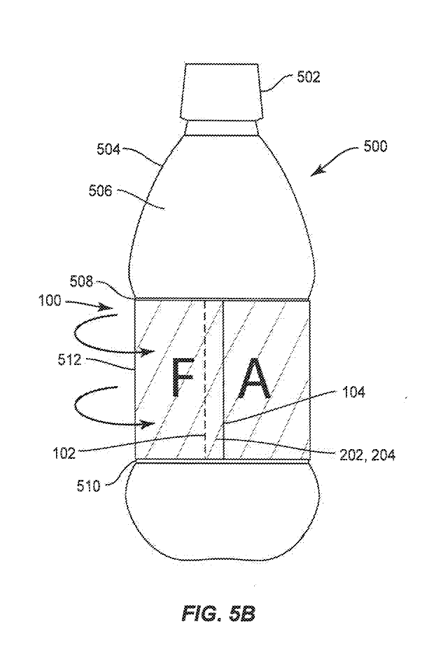

FIG. 5A illustrates the application of the base label 100 to an exemplary container 500 according to various embodiments. The container 500 may be a glass or plastic bottle, or other type of container such as a metal can or a cardboard receptacle. The container may be round, rectangular, square, or any other shape known in the art. The term “container” is used here for convenience to describe exemplary embodiments. It is understood that the container may be any object, including non-containers. Container 500 may comprise a cap 502 removably secured to a body 504. Various embodiments of the body 504 may have an exterior surface 506 that comprises a upper label panel 508, a lower label panel 510, and a recessed surface 512 interposed between the upper label panel 508 and the lower label panel 510. As discussed below, the base label 100 may be applied to the container 500 at the recessed area 512 between the upper label panel 508 and the lower label panel 510.

In various embodiments, the top label 300 may be rotatable about the base label 100, as discussed below. In these embodiments, the upper label panel 508 and lower label panel 510 may function to restrict upward and downward movement of the top label 300 in relation to the container 500 such that the top label 300 generally remains in a position covering at least a portion of the base label 100.

FIG. 5B illustrates the container 500 with the base label 100 affixed to the container 500. Initially, as illustrated in FIG. 5A, base label leading edge 102 is placed in contact with the recessed surface 512 of the container 500 and affixed to the container 500 by the leading edge adhesive strip 202. With relative motion between the container 500 and the base label 100, the base label 100 may be wrapped around the container 500 with the base label trailing edge 104 now overlapping the base label leading edge 102 such that the leading edge adhesive strip 202 holds the base label leading edge 102 to the container 500 while the trailing edge adhesive strip 204 holds the base label trailing edge 104 to the overlapped base label leading edge 102.

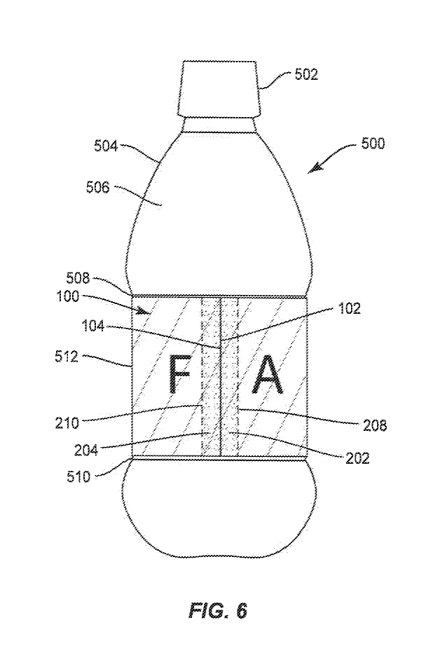

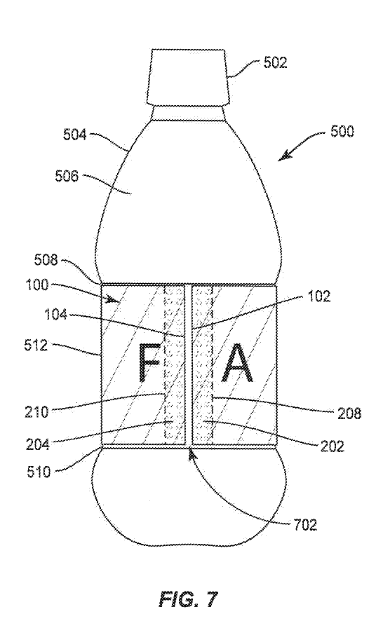

In various embodiments as illustrated in FIG. 6, the length of the base label 100 may be substantially the same as a circumference of the recessed surface 512 of the container 500, which may allow the base label leading edge 102 and base label trailing edge 104 to abut rather than overlap. However, it is also possible that the length of the base label 100 may be shorter than the circumference of the recessed surface 512, resulting in a gap 702 between the base label leading edge 102 and the base label trailing edge 104 when the base label 100 is affixed to the recessed surface as illustrated in FIG. 7. In both of these instances, the base label trailing edge adhesive strip 204 may adhere to the recessed surface 512 of the container 500, rather than the base label leading edge 102.

In various embodiments, the base label adhesive strips 202, 204 may comprise a permanent adhesive. In general, a permanent adhesive is one that does not readily release from a surface to which it adheres after the adhesive dries or cures. Using the base label 100 as an example, the permanent adhesive 202, 204 will tend not to release from the recessed surface 512, nor will it tend to release the base label leading edge 102 or trailing edge 104 once dried or cured. In order to remove the base label from the recessed surface 512, the base label 100 may have to be torn from the adhesive, or the adhesive layer 202, 204 may have to be fractured which may leave some of the adhesive on the recessed surface 512 and some of the adhesive on the base label leading edge 102 or trailing edge 104. Once the surfaces affixed with the permanent adhesive are separated, they may not be reattached.

In FIG. 8, the base label 100 is already affixed to the recessed surface 512 of the container 500, and the application of the top label 300 over the base label 100 is illustrated according to various embodiments. The top label leading edge 302 may be placed in contact with any portion of the base label front surface 108 and affixed to the base label front surface 108 by the top label leading edge adhesive strip 404. With relative motion between the container 500 and the top label 300, the top label 300 may be wrapped around the container 500 with the top label trailing edge 304 now overlapping the top label leading edge 302 such that the top label leading edge adhesive strip 404 holds the top label leading edge 302 to the base label 100 while the top label trailing edge adhesive strip 406 holds the top label trailing edge 304 to the overlapped top label leading edge 302.

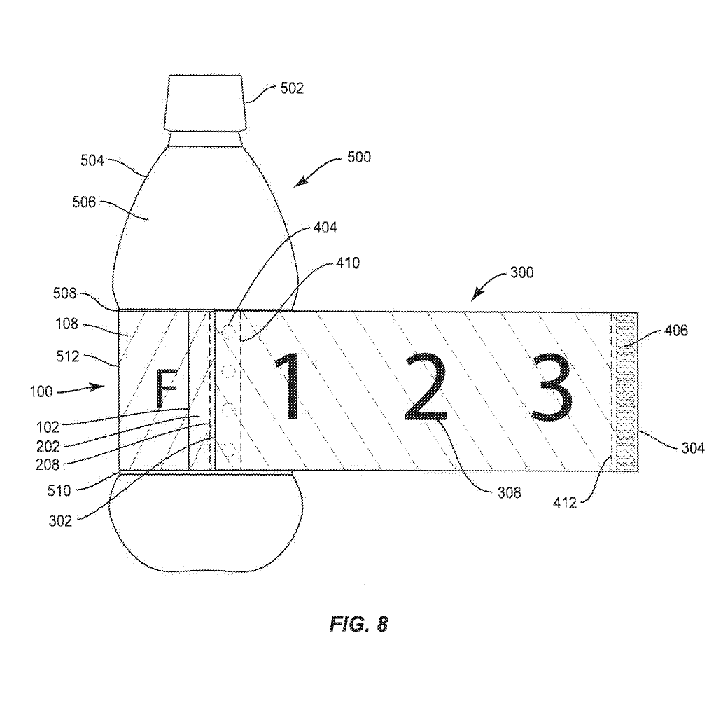

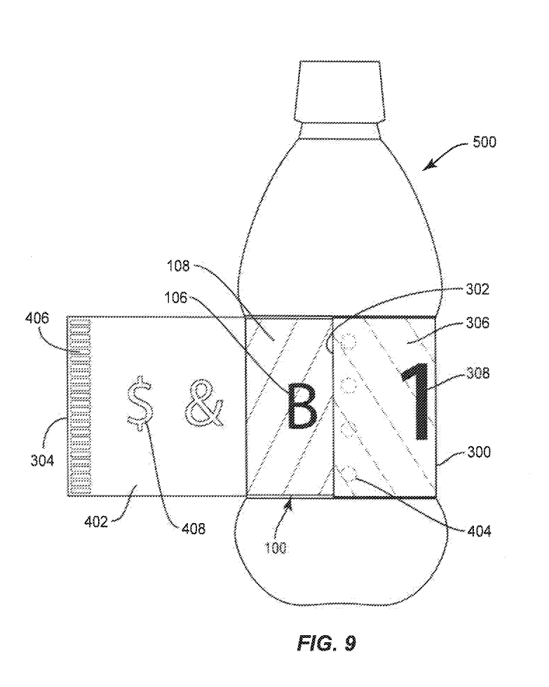

FIG. 9 illustrates the operation of the base label 100 and the top label 300 according to various embodiments. Beginning with the container 500 with the base label 100 and the top label 300 in place as shown, for example, in FIG. 6, the top label trailing edge 304 may be detached from the top label leading edge 302 and at least partially peeled back as shown in FIG. 9. The combination of the base label 100 and the top label 300 in this configuration increases the amount of surface area available for viewing by a consumer or user of the container 500. Prior to detaching the top label trailing edge 304, the consumer may view the top label front surface 306. Upon detaching the top label trailing edge 304, the consumer may now view the top label back surface 402 and the base label front surface 108 in addition to the top label front surface 306.

One of at least three types of adhesive may be used for the top label leading edge adhesive 404. A first type of adhesive is the permanent adhesive as described above for the base label 100. When a permanent adhesive is used for the top label leading edge adhesive 404, the top label leading edge generally cannot be detached without inflicting damage to one or both of the top label 300 or the base label 100. This may be desirable for various embodiments where the top label 300 is not intended to be removed from the container 500.

A second type of adhesive that may be used for the top label leading edge adhesive 404 is a releasable adhesive. A releasable adhesive is one that will release from a surface to which it is attached once a sufficient mechanical force is applied. A releasable adhesive may be used, for example, when the top label back surface 402 comprises a coupon for a subsequent purchase of a product. The releasable adhesive may allow the consumer to easily remove the top label 300 for later use. In various embodiments, the releasable adhesive may be a breakaway adhesive. A breakaway adhesive may have limited ability to withstand shear stresses. Shear stresses may cause the adhesive bond created between the label (e.g., top label 300) and the surface to which it is affixed (e.g., the base label 100 or container 500) to fail along the adhesive. In general, a releasable or breakaway adhesive may not re-attach to a surface once removed.

A third type of adhesive that may be used for the top label leading edge adhesive 404 is a resealable adhesive. A resealable adhesive may release from a surface to which it is attached once a sufficient mechanical force is applied, similar to the releasable adhesive described above. However, the resealable adhesive may be re-attached to a surface by applying pressure. A resealable adhesive may be desirable when the top label back surface 402 or the base label front surface 108 comprise information that may be needed only on occasion. Thus, the consumer or user may detach the top label 300 when the information is needed, then re-attach the top label 300.

In various embodiments, the top label trailing edge adhesive 406 may be a releasable adhesive or a resealable adhesive, depending on the intended use of the top label 300. As described above, if the surfaces 108, 402 comprise information that is intended to stay with the container, the top label trailing edge adhesive 406 may be a resealable adhesive. In contrast, if the top label 300 is intended to be removed from the container 500, a releasable adhesive may be desirable.

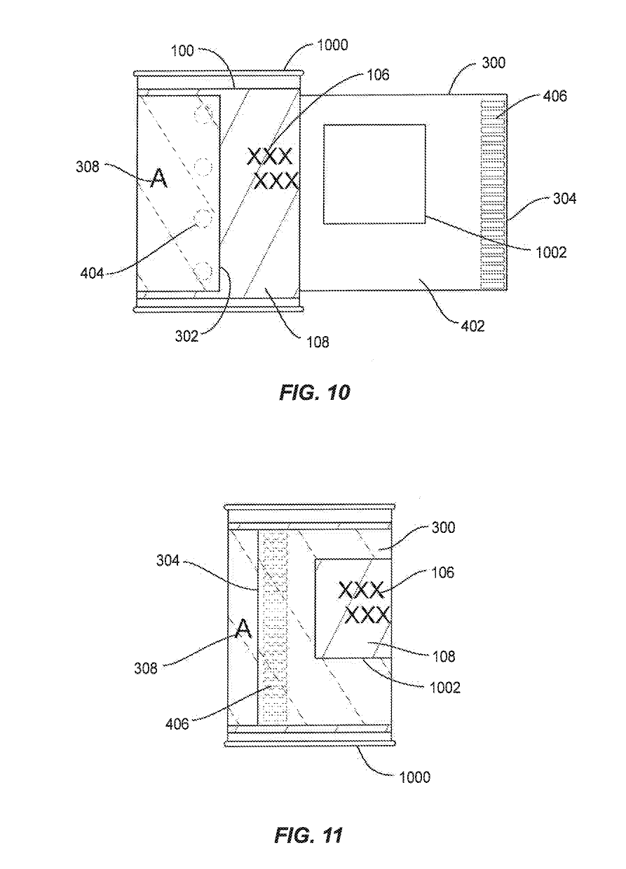

FIG. 10 illustrates various embodiments of the top label 300 comprising a window 1002. The window 1002 may comprise a void in the top label 300 such that a portion of the base label 100 may be visible through the window. In various embodiments, the window 1002 may have a transparent covering (not shown). In various other embodiments, the window may comprise a transparent section of the top label 300 itself rather than a void. FIG. 10 illustrates the top label 300 partially wrapped about a container 1000, and base label 100 already in place on the container 1000. As shown, the top label leading edge adhesive 404 maintains the top label 300 coupled to the base label 100. The top label 300 may then be moved from the position illustrated in FIG. 10 to the position illustrated in FIG. 11 to secure the top label 300 about the container 1000. Top label trailing edge adhesive 406 may couple to the top label leading edge 302 if the top label leading edge 302 and trailing edge 304 overlap; otherwise, the top label trailing edge adhesive 406 may be coupled to the base label front surface 108.

Once the top label 300 is in position on the container 1000 as illustrated in FIG. 11, at least a portion of the base label front surface indicia 106 may be visible through the window 1002. This may allow viewing of a first portion of the base label 100 without removing the top label 300. In various embodiments, the top label leading edge adhesive 404 may be a breakaway adhesive. Rotation of the top label 300 relative to the base label 100 may exert shear stresses on the breakaway adhesive, causing the adhesive bond affixing the top label leading edge 302 to the base label 100 to fail. The top label 300 may then be freely rotatable about the base label 100, and a second portion of the base label 100 may be visible when the top label 300 is rotated to a second position. The window 1002 may be rectangular as illustrated in FIGS. 10 and 11, or any other shape as needed for a particular application. For example, the window 1002 may be a slit that reveals an alphanumeric string on the base label 100. In various embodiments, the top label 300 may comprise more than one window 1002. Various embodiments in which the top label trailing edge adhesive 406 is a resealable or releasable adhesive may allow the top label 300 to be peeled back to reveal the top label back surface 402 and essentially the entire base label front surface 108 or to be removed from the container 1000, in addition to being rotatable.

One skilled in the art will readily recognize that labels may be applied to containers using a variety of methods and that there may be a variety of single-label and multi-label systems other than those described above. Any such application methods or label systems may be used with the present disclosure. The above descriptions are exemplary and not to be construed as limiting in any way. Examples of other application methods and label systems may be disclosed in U.S. Pat. Nos. 5,884,421, 6,086,697, 6,237,269, 6,402,872, 6,631,578, 6,649,007, 7,087,298, and 7,172,668.

The label systems described above and illustrated in FIGS. 1 through 11 may comprise pressure sensitive, roll fed, or cut and stack labels, which generally require a flat surface on the container for mounting. For example, the container 500 in FIGS. 5A and 5B comprises recessed surface 512 in which the sides, as viewed in a front view as in FIGS. 5A and 5B, are straight and parallel to one another. Similarly, FIG. 10 illustrates a container 1000 with sides that are straight and parallel when viewed from the front of the container 1000. The base label 100 and top label 300 are placed on the “flat” surface. However, not all containers comprise a flat surface for mounting a label. Due to functional and aesthetic concerns, there may be no surfaces on the container with parallel sides on which to mount a label.

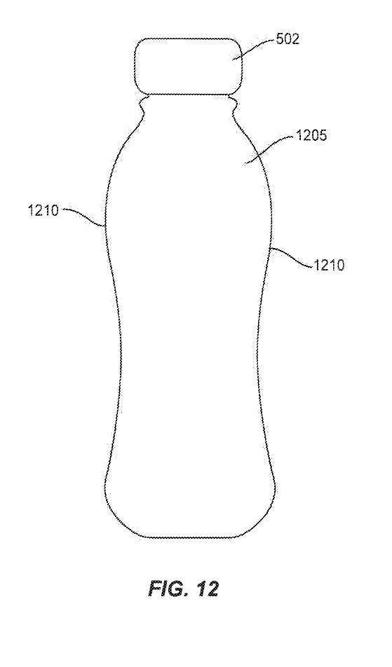

FIG. 12 illustrates various embodiments of a container 1205 with non-parallel sides 1210. Placing a label on such a container 1205 may result in buckling and creasing of the label, and adhesion of the label to a surface of the container 1205 may be unsatisfactory. Various embodiments of the label system described herein may provide solutions to these problems, as well as providing the manufacturer with expanded labeling space to present information to the consumer without resorting to separate inserts, leaflets, or other packaging.

According to various embodiments, label systems may comprise a base label 100 and top label 300 both of which comprise a material that dimensionally shrinks when exposed to an energy source. Such a material, commonly known as “shrink wrap,” may comprise a thermoplastic packaging film manufactured from resins such as polyolefins or polyvinyl chlorides. The shrink wrap may also comprise, individually or in mixtures, ionomers, polyesters, polystyrenes, polyvinylidene chlorides, polypropylene terephthalate, low shrink force polypropylene terephthalate, oriented polystyrene, and polylactic acid among others. The shrink wrap material may comprise a monolayer or a multilayer construction. The energy source may be heat, such as a hot air or hot water stream, radiant heat, ultraviolet light, and may include irradiation when cross-linking of the resin is desired, or any energy source known in the art either singly or in combination.

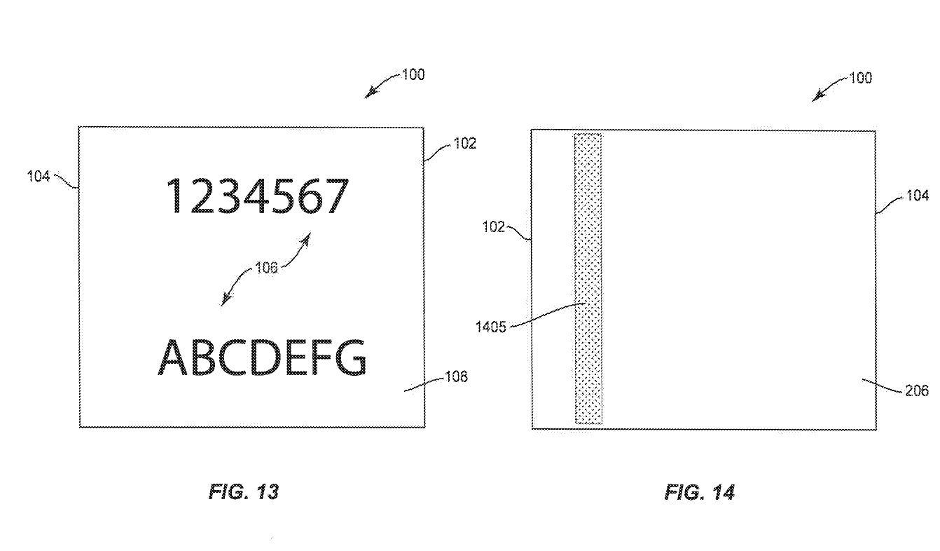

FIG. 13 illustrates a base label 100 made from a shrink wrap material, and may contain printed information 106 thereon. For some uses, it may be desirable to couple the base label 100 to the container 1205 to prevent movement of the base label 100, and an adhesive 1405 (as described above or as known in the art) may be applied to all or a portion of the base label back surface 206, which will be in contact with the container 1205. In alternate embodiments, the adhesive 1405 may be applied to the container 1205 prior to applying the base label 100 as illustrated in FIG. 17, either with or without adhesive 1405 applied to the base label back surface 206.

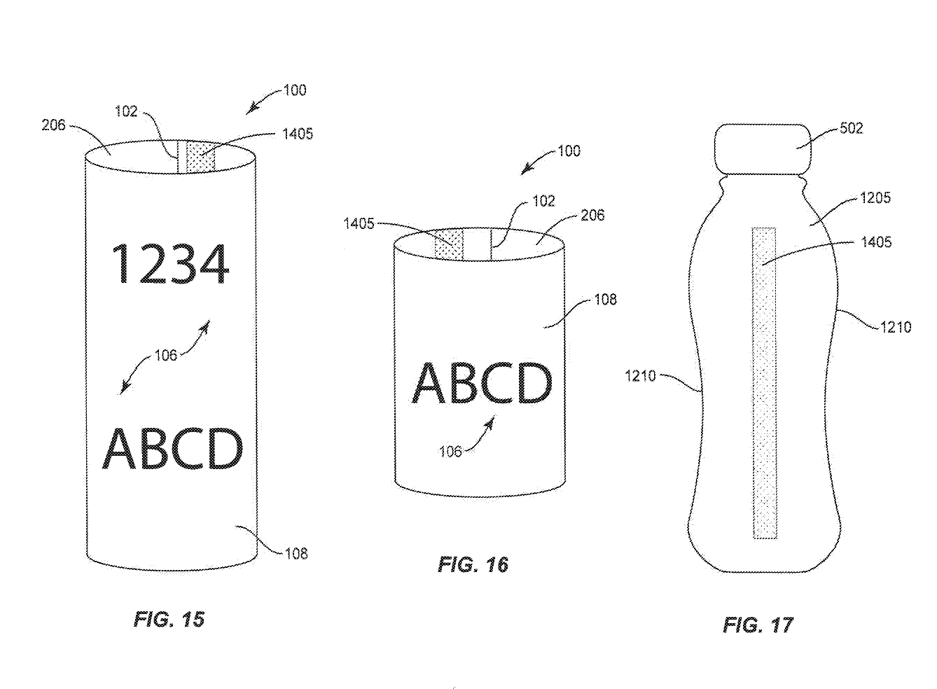

FIG. 15 illustrates the base label 100 rolled into a cylindrical shape by joining or overlapping leading edge 102 and trailing edge 104. Alternatively, the base label 100 may be provided as a continuously formed cylinder which is cut to the desired length prior to application on the container 1205. In further embodiments, the base label 100 (and the top label 300) may be supplied in roll form which is cut into individual sheets and applied like conventional roll-fed labels (not shown). While FIG. 15 illustrates a base label 100 that covers nearly the entire outer surface of the container 1205, certain uses of the label system may require only a portion of the container 1205 to be covered by the base label 100. Thus, FIG. 16 illustrates the base label 100 (or the continuously formed cylinder) cut to a smaller length than the base label 100 of FIG. 15.

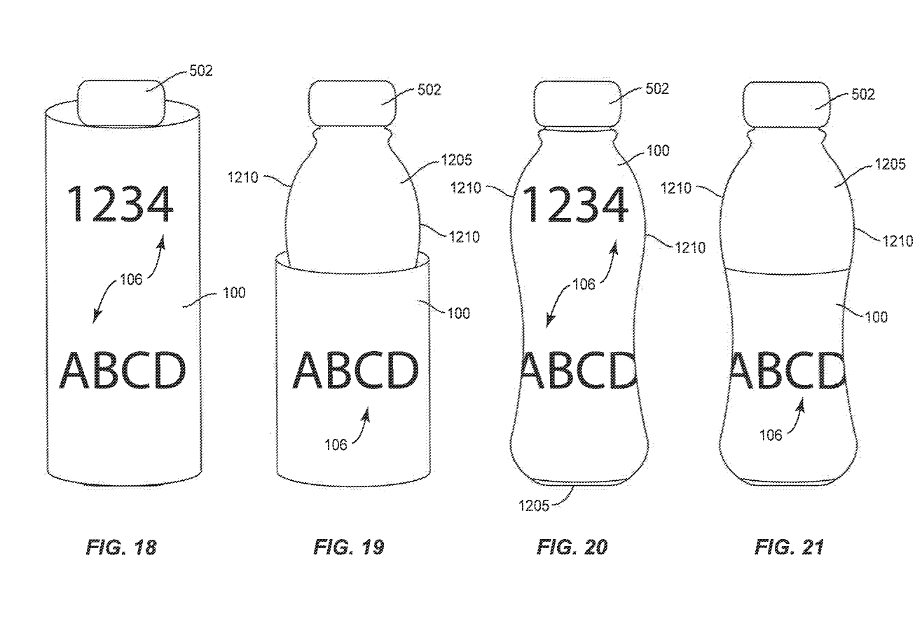

The non-shrunk base label 100 may then be placed around the container 1205 as illustrated in FIG. 18 for a full length base label 100 and FIG. 19 for a partial length base label 100. The base label 100 may then be exposed to an energy source which causes the base label 100 to shrink and smoothly conform to the non-parallel sides 1210 of the container 1205 as illustrated in FIGS. 20 and 21.

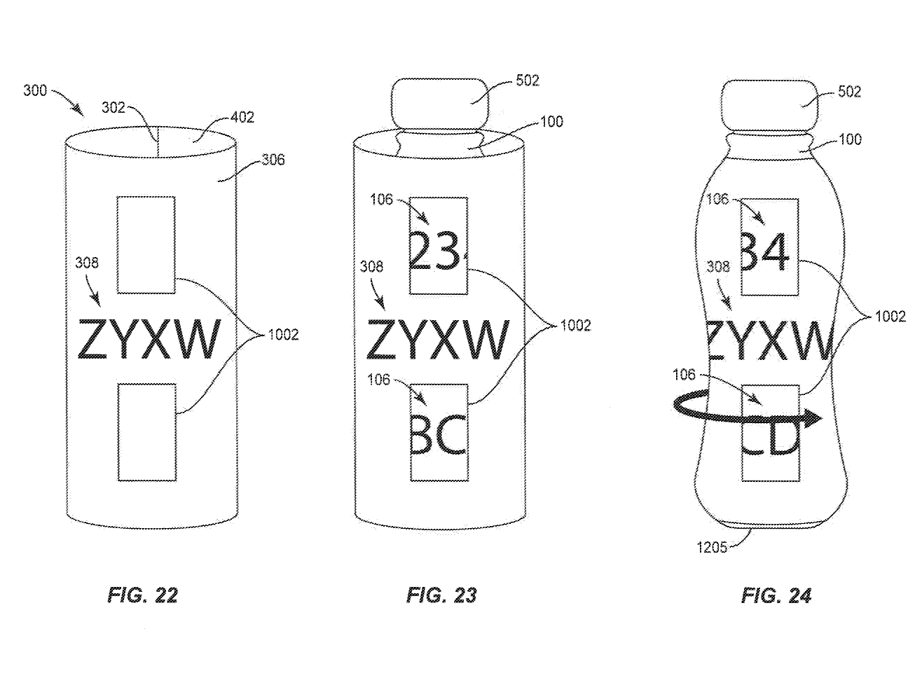

In various embodiments, the top label 300 may also comprise a heat shrink material to also conform to the non-parallel sides 1210 of container 1205. FIG. 22 illustrates the top label 300 in cylindrical form ready for placement around the container 1205. Various embodiments of the top label 300 may comprise one or more windows 1002. Once the top label 300 is applied to the container 1205, a portion of the printed information 106 on the base label 100 may be visible through the windows 1002. In various embodiments, the windows 1002 may be formed by removing a portion of the top label 300, creating a hole through which the printed information 106 is visible. In other embodiments, the top label 300 may comprise a transparent material, and second printed information 308, which may comprise opaque areas of printing as well as alphanumeric characters, may define the windows 1002. Thus, areas of the top label 300 with no second printed information 308 may function as a window 1002 when the top label 300 is made from a transparent material.

In FIG. 23, the non-shrunk top label 300 is placed over the container 1205 with base label 100 already in place on the container 1205. The top label 300 may then be exposed to an energy source, which causes the top label 300 to shrink and smoothly conform to the non-parallel sides 1210 of the container 1205 as shown in FIG. 24. The top label 300 may be free to rotate about the base label 100 as indicated by the arrow in FIG. 24, progressively displaying the printed information 106 on the base label 100.

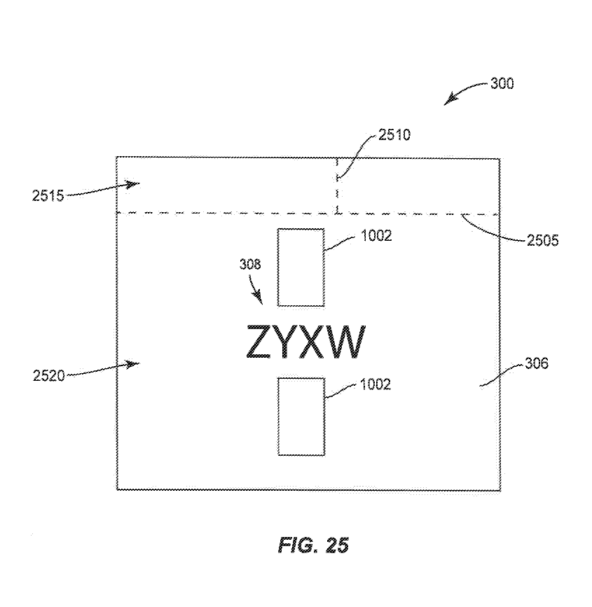

Making use of the shrink wrap nature of the label system, either the base label 100 or the top label 300 may comprise a tamper evident feature. Various embodiments of the top label 300 may comprise a first section 2515 and a second section 2520 as illustrated in FIG. 25. The first section 2515 may be positioned about a top portion of the container 1205, which may include the cap (or more generally, a closure device for the container 1205) 502 and, if present, a dispensing device, such as a measuring cup (not shown). The second section 2520 may be positioned around a bottom portion of the container 1205. The first section 2515 and the second section 2520 of the top label 300 may be coupled to one another by a first perforation 2505. The first perforation 2505 may allow the consumer to decouple the first section 2515 to reveal the cap 502. The first section 2515 may also comprise one or more tamper evident perforations 2510 that may intersect the first perforation 2505. In various embodiments, it may be difficult to remove the first section 2515 without first tearing or separating the first section 2515 along the tamper evident perforation 2510. Thus, any tearing or separating of the tamper evident perforation 2510 may indicate previous tampering. In various embodiments, the first section 2515 and the second section 2520 of the top label 300 may comprise different thermoplastics such that the shrinkage rate of the first section 2515 is different than that of the second section 2520.

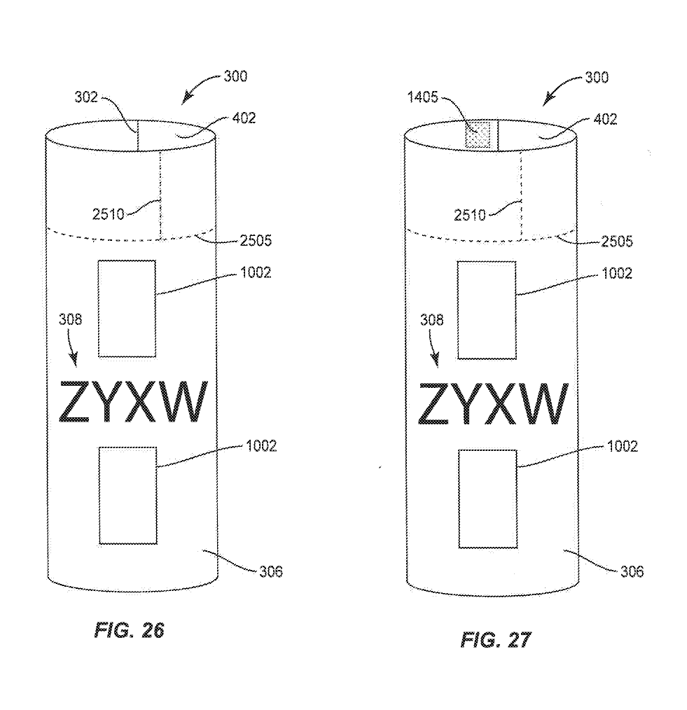

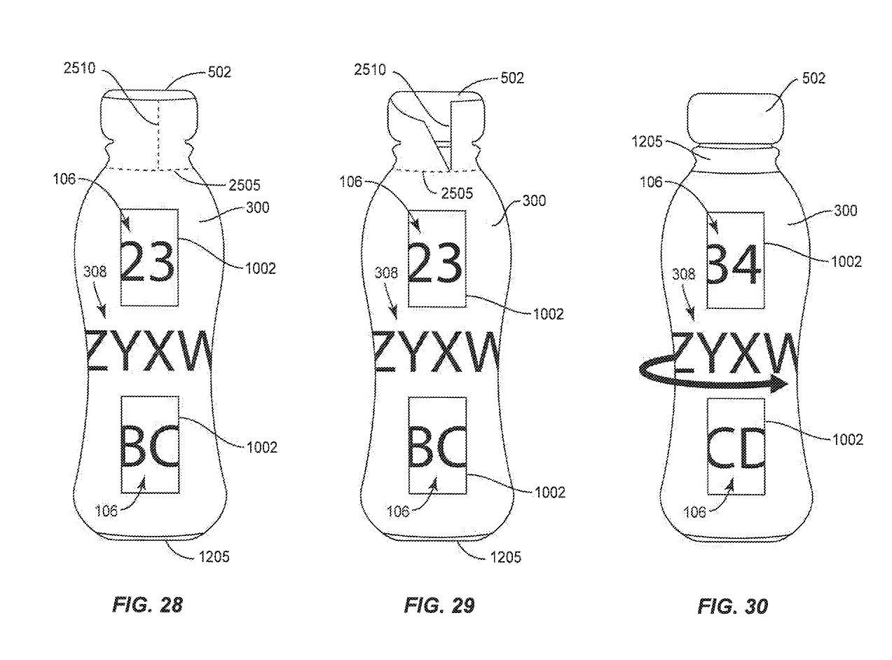

In FIG. 26, the top label 300 maybe formed into a cylindrical shape by coupling or overlapping the leading edge 302 and the trailing edge 304 as described previously. The cylindrical top label 300 may then be placed over the container 1205 and shrunk as described previously to conform to the non-parallel sides 1210 of the container 1205 as illustrated in FIG. 28, with the first section 2515 conforming to the cap (or other closure device) 502 such that the cap 502 may not be removed without tearing the tamper evident perforation 2510 as shown in FIG. 29. In FIG. 30, the first section 2515 may be completely decoupled from the second section 2520, exposing the cap 502.

As shown in FIG. 28, conforming the first section 2515 of the top label 300 to the cap 502 may, for all practical purposes, restrict the top label 300 from rotating. After the first section 2515 is removed, the top label 300 may then be free to rotate as indicated by the arrow in FIG. 30. In certain other embodiments, shrinking the first section 2515 to conform to the cap 502 may not completely restrict rotation of the top label 300 while the first section 2515 is still in place. Thus, an adhesive 1405 may be placed only on the top label back surface 402 as illustrated in FIG. 27.

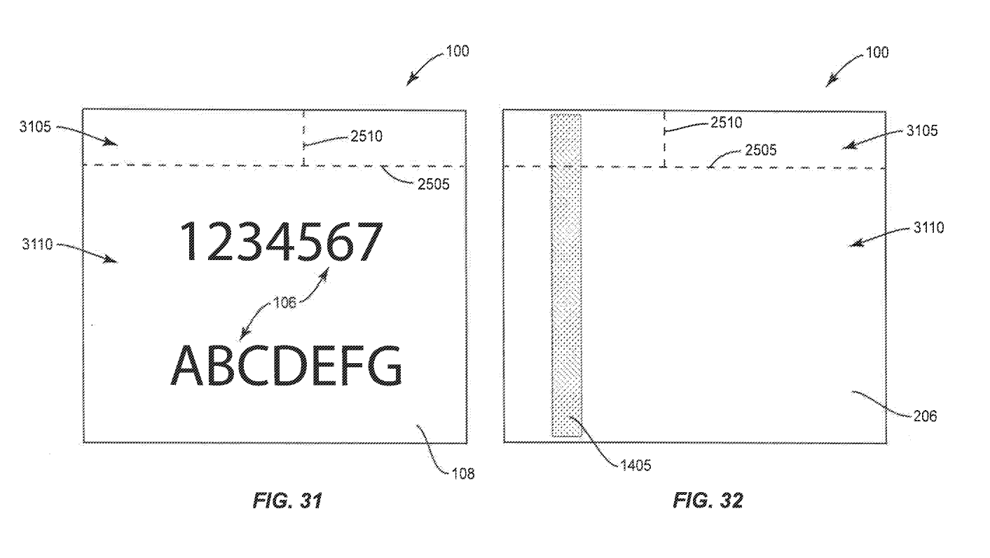

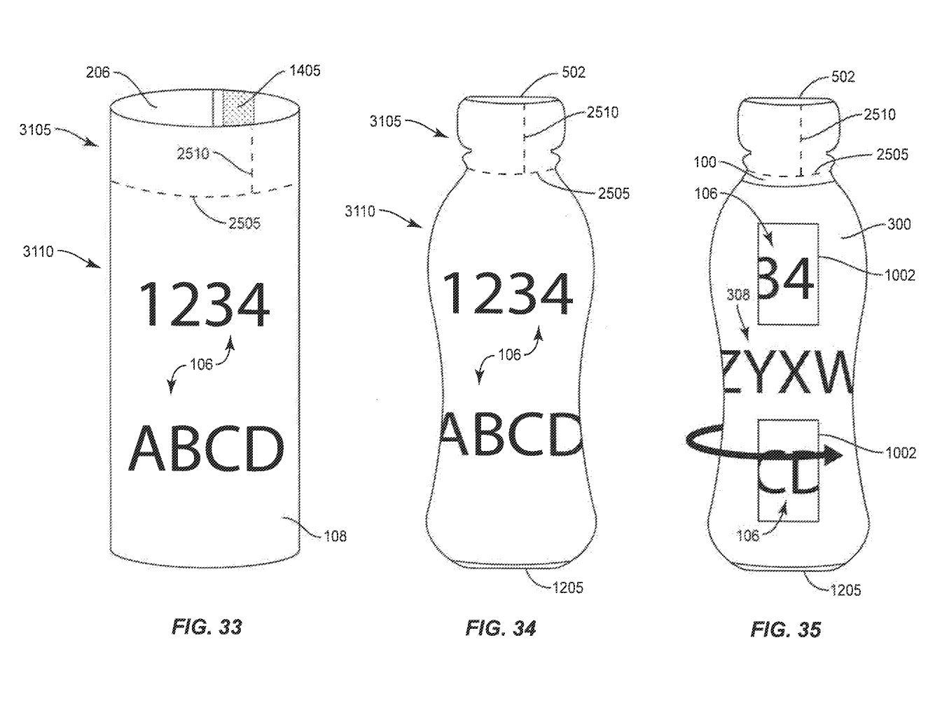

Similarly, FIGS. 31 through 33 illustrate a base label 100 with a first section 3105 and a second section 3110 coupled at first perforation 2505. The base label 300 may comprise an adhesive 1405 as described previously that may be positioned on either or both of the first section 3105 and the second section 3110 (FIG. 32). After forming the base label 100 into a cylindrical shape (FIG. 33), the base label 100 may be exposed to an energy source causing the base label 100 to conform to the non-parallel sides 1210 of the container 1205 as illustrated in FIG. 34. The first section 3105 may conform to the cap 502 and may be removed by tearing along the first perforation 2505 and the tamper evident perforation 2510 as described previously. The top label 300 may then be shrunk to conform to the non-parallel sides 1210 of the container 1205 as shown in FIG. 35.

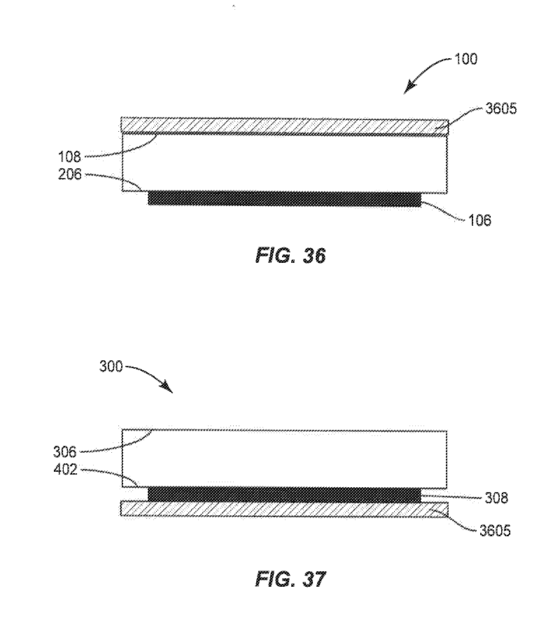

Because the top label 300 comprises a shrinkable material, after shrinking there may be intimate contact between the top label back surface 402 and the base label front surface 108. This contact may create a strong frictional force that impedes rotation of the top label 300. Additionally, the frictional contact may abrade any printed information 308 on the top label 300 or printed information 106 on the base label 100. According to various embodiments as illustrated in FIG. 36, the base label 300 may comprise a transparent material which may allow the printed information 106 of the base label 300 to be printed on the base label back surface 208 such that printed information 106 is adjacent to the outer surface of the container 1205 and will be visible through the transparent material. The printed information 106 would be positioned away from the top label 300 such that the printed information 106 would not be abraded by the rotating top label 300. A friction reducing coating 3605 may be placed on the base label front surface 108 to reduce friction with the rotating top label 300. As illustrated by various embodiments in FIG. 37, the top label 300 may also comprise a transparent material. The printed information 308 of the top label 300 may be printed on the top label back surface 402 such that the printed information 308 is visible through the transparent material. Placing the printed information 308 on the top label back surface 402 protects the printed information 308 from abrasion due to handling. In addition, the friction reducing coating 3605 may be placed over the printed information 308 and the top label back surface 402 to protect the printed information 308 from abrasion when the top label 300 is rotated.

In order to allow the top label 300 to rotate about the base label 100, the tension of the shrink wrap material after shrinking may be controlled so that the top label 300 conforms to the shape of the container 1205 but not so tightly that it cannot rotate. During the heating process, the tension may be controlled by varying the temperature to which the top label 300 is exposed such that the top label 300 shrinks but does not adhere to the container 1205 or the base label 100. The first section 2515 of the top label 300 (or the first section 3105 of the base label 300) may be exposed to a different temperature than the second section 2520 of the top label 300 (or the second section 3110 of the base label 100) such that the tension of the first section 2515, 3105 is greater than the tension of the second section 2520, 3110. Alternatively, as described previously, the first section 2515, 3105 and the second section 2520, 3110 may comprise different thermoplastic resins that shrink different amounts when exposed to the same temperature.

Returning to FIGS. 28 through 30, the functionality of the tamper evident perforation 2510 is illustrated according to various embodiments. Once the top label 300 is shrunk to conform to the container 1205, any attempt to remove the first section 2515 of the top label 300 will be evident by the tearing at the tamper evident perforation 2510. As the tearing along the tamper evident perforation 2510 continues, the tear may eventually reach the first perforation 2505, redirecting the tear along the first perforation 2505 as illustrated in FIG. 29. Continuing to tear along the first perforation 2505 around the circumference of the container 1205 may allow the first section 2515 of the top label 300 to be decoupled from the second section 2520, thereby exposing the cap 502 as illustrated in FIG. 30. Decoupling the first section 2515 from the second section 2520 may also allow the second section 2520 to rotate about the container 1205.

The top label 300 may comprise a dual ply (or multi-ply) construction in which a ply in contact with the base label 100 is a material selected for low sliding friction characteristics. The low sliding friction characteristics may enhance the ease of rotating and sliding the top label 300 about the base label 100. In various embodiments, the top label 300 ply in contact with the base label 100 may be coated with a substance to impart the low sliding friction characteristics.

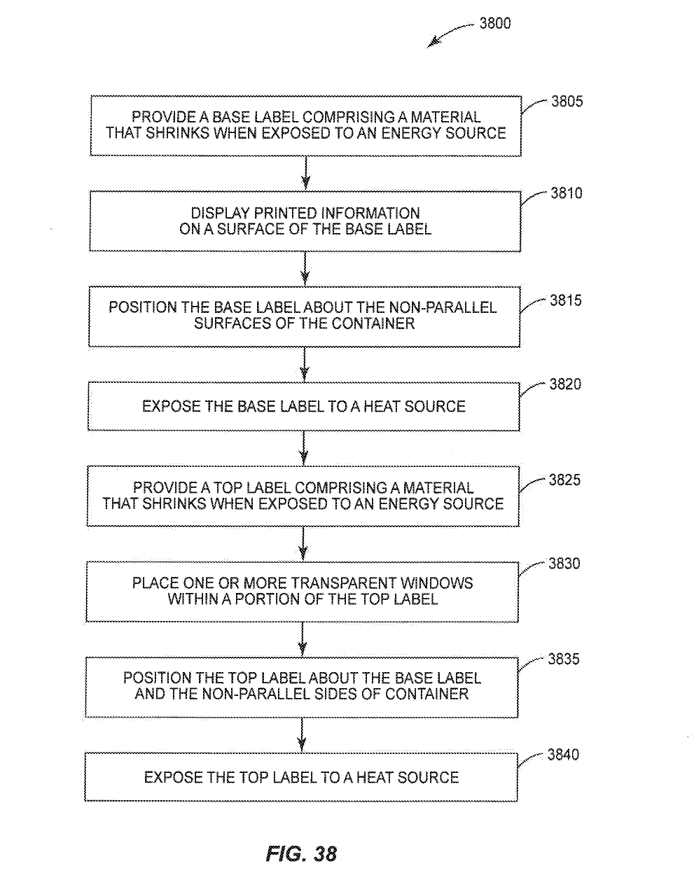

FIG. 38 illustrates a general flow chart of various embodiments of a method 3800 for delivering information associated with a container 1205 having non-parallel surfaces 1210. A base label 100 comprising a material that shrinks when exposed to an energy source may be provided (step 3805). At step 3810, printed information 106 may be displayed on a surface of the base label 100, and the base label 100 may be positioned about the non-parallel surfaces 1210 at step 3815. The base label 100 may then be exposed to an energy source such that the base label 100 shrinks and non-rotatably conforms to the non-parallel surfaces 1210 of the container 1205 (step 3820). A top label 300 may be provided at step 3825 comprising a material that shrinks when exposed to an energy source. At step 3830, one or more transparent windows 1002 may be placed within a portion of the top label 300 such that at least a portion of the printed information 106 on the base label 100 may be displayed in the windows 1002. The top label 300 may then be placed about the base label 100 and the non-parallel sides 1210 of the container 1205 at step 3835, and then the top label 300 may be exposed to an energy source such that the top label 300 rotatably conforms to the non-parallel surfaces 1210 of the container 1205 at step 3840.

In various embodiments, all or a portion of the indicia 106 may be imprinted, embossed, or molded directly on an outer surface of the container 1205 in place of all or a portion of the base label 100. The imprinting or embossing may be carried out using any printing or image transfer method known in the art. In various embodiments, the printing or image transfer method may be an offset process in which an image is transferred from a plate to an intermediate carrier, then to the outer surface of the container 1205. The offset process may also involve lithographic techniques. Other printing or image transfer methods may comprise, for example, flexography, pad printing, relief printing, rotogravure, screen printing, and electrophotography. According to various embodiments, the indicia 106 may be digitally printed on the outer surface of the container 1205 using, for example, inkjet printing or laser printing. Chemical printing technologies, such as blueprint or diazo print may also be used in various embodiments.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A rotating shrink label system for a container having non-parallel surfaces, comprising:
a base label adhered to the non-parallel surfaces of the container, the base label comprising a material that shrinks when exposed to an energy source and having a surface with printed information thereon;
a rotating top label covering at least a portion of the base label, the top label comprising a material that shrinks when exposed to an energy source; and
one or more transparent windows within the top label, the transparent window allowing at least a portion of the printed information to be visible through the transparent window.

2. The system of claim 1, wherein the base label comprises a transparent material.

3. The system of claim 2, wherein the base label comprises a base label back surface positioned adjacent to the non-parallel surfaces of the container, and a base label front surface opposite the base label back surface.

4. The system of claim 3, wherein the printed information is printed on the base label back surface such that the printed information is visible through the transparent base label.

5. The system of claim 3, wherein the base label further comprises a coating applied to at least a portion of the base label front surface to reduce friction between the base label and the rotating top label.

6. The system of claim 1, wherein the rotating top label comprises a transparent material.

7. The system of claim 6, wherein the rotating top label comprises a top label back surface positioned adjacent to the base label front surface, and a top label front surface opposite the top label back surface.

8. The system of claim 7, wherein the rotating top label further comprises second printed information printed on at least a portion of the top label back surface such that the second printed information is visible through the transparent top label.

9. The system of claim 8, wherein the rotating top label further comprises a coating applied to at least a portion of the second printed material and at least a portion of the top label back surface to reduce friction between the base label and the rotating top label.

10. The system of claim 3, further comprising an adhesive applied to at least a portion of the base label back surface to non-rotatably couple the base label to the surface.

11. The system of claim 1, wherein the base label comprises a first shrinkable material, and the rotating top label comprises a second shrinkable material different from the first shrinkable material.

12. The system of claim 1, wherein the window allows differing portions of the printed material to be visible through the window as the top label is rotated.

13. The system of claim 8, wherein the top label comprises printing or shading to define the window.

14. The system of claim 1, wherein the energy source is a heated air stream, steam, radiant heat, or ultraviolet light.

15. A rotating shrink label system for a container having non-parallel surfaces, comprising:
a base label adhered to the non-parallel surfaces of the container, the base label comprising:
a material that shrinks when exposed to an energy source;
a surface with printed information thereon;
a first section positioned about an upper portion of the container;
a second section positioned about a lower portion of the container and coupled to the first section by a perforation;
a rotating top label covering at least a portion of the base label, the top label comprising a material that shrinks when exposed to an energy source; and
one or more transparent windows within the top label, the transparent window allowing at least a portion of the printed information to be visible through the transparent window.

16. The system of claim 15, wherein the perforation comprises at least a portion of a tamper evident feature.

17. The system of claim 15, wherein decoupling the base label first section from the second section and removing the first section from the container reveals a closure device on the container.

18. The system of claim 15, wherein the base label comprises a transparent material.

19. The system of claim 18, wherein the base label comprises a base label back surface positioned adjacent to the non-parallel surfaces of the container, and a base label front surface opposite the base label back surface.

20. The system of claim 19, wherein the printed information is printed on the base label back surface such that the printed information is visible through the transparent base label.

21. The system of claim 19, wherein the base label further comprises a coating applied to at least a portion of the base label front surface to reduce friction between the base label and the rotating top label.

22. The system of claim 15, wherein the rotating top label comprises a transparent material.

23. The system of claim 22, wherein the rotating top label comprises a top label back surface positioned adjacent to the base label front surface, and a top label front surface opposite the top label back surface.

24. The system of claim 23, wherein the rotating top label further comprises second printed information printed on at least a portion of the top label back surface such that the second printed information is visible through the transparent top label.

25. The system of claim 24, wherein the rotating top label further comprises a coating applied to at least a portion of the second printed material and at least a portion of the top label back surface to reduce friction between the base label and the rotating top label.

26. A rotating shrink label system for a container having non-parallel surfaces, comprising:
a base label adhered to the non-parallel surfaces of the container, the base label comprising a material that shrinks when exposed to an energy source and having a surface with printed information thereon;
a rotating top label covering at least a portion of the base label, the top label comprising:
a material that shrinks when exposed to an energy source;
a first section positioned about an upper portion of the container;
a second section positioned about a lower portion of the container and coupled to the first section by a perforation; and
one or more transparent windows within the top label, the transparent window allowing at least a portion of the printed information to be visible through the transparent window;
wherein decoupling the top label first section from the second section allows the second section to rotate about the container.

27. The system of claim 26, wherein the perforation comprises at least a portion of a tamper evident feature.

28. The system of claim 26, wherein decoupling the top label first section from the second section and removing the first section from the container reveals a closure device on the container.

29. The system of claim 26, wherein the base label comprises a transparent material.

30. The system of claim 29, wherein the base label comprises a base label back surface positioned adjacent to the non-parallel surfaces of the container, and a base label front surface opposite the base label back surface.

31. The system of claim 30, wherein the printed information is printed on the base label back surface such that the printed information is visible through the transparent base label.

32. The system of claim 30, wherein the base label further comprises a coating applied to at least a portion of the base label front surface to reduce friction between the base label and the rotating top label.

33. The system of claim 26, wherein the rotating top label comprises a transparent material.

34. The system of claim 33, wherein the rotating top label comprises a top label back surface positioned adjacent to the base label front surface, and a top label front surface opposite the top label back surface.

35. The system of claim 33, wherein the rotating top label further comprises second printed information printed on at least a portion of the top label back surface such that the second printed information is visible through the transparent top label.

36. The system of claim 35, wherein the rotating top label further comprises a coating applied to at least a portion of the second printed material and at least a portion of the top label back surface to reduce friction between the base label and the rotating top label.

37. A method for delivering information associated with a container, the container having non-parallel surfaces, comprising:
providing a base label comprising a material that shrinks when exposed to an energy source;
displaying printed information on a surface of the base label;
positioning the base label about the non-parallel surfaces of the container;
exposing the base label to a heat source such that the base label shrinks and non-rotatably conforms to the non-parallel surfaces of the container;
providing a top label comprising a material that shrinks when exposed to an energy source;
placing one or more transparent windows within a portion of the top label, the transparent window displaying at least a portion of the printed information;
positioning the top label about the base label and the non-parallel sides of the container; and
exposing the top label to an energy source such that the top label shrinks and rotatably conforms to the non-parallel surfaces of the container.

38. The method of claim 37, wherein the base label comprises a transparent material.

39. The method of claim 38, wherein the base label comprises a base label back surface positioned adjacent to the non-parallel surfaces of the container, and a base label front surface opposite the base label back surface.

40. The method of claim 39, wherein the printed information is printed on the base label back surface such that the printed information is visible through the transparent base label.

41. The method of claim 39, wherein the base label further comprises a coating applied to at least a portion of the base label front surface to reduce friction between the base label and the rotating top label.

42. The method of claim 37, wherein the rotating top label comprises a transparent material.

43. The method of claim 42, wherein the rotating top label comprises a top label back surface positioned adjacent to the base label front surface, and a top label front surface opposite the top label back surface.

44. The method of claim 43, wherein the rotating top label further comprises second printed information printed on at least a portion of the top label back surface such that the second printed information is visible through the transparent top label.

45. The method of claim 44, wherein the rotating top label further comprises a coating applied to at least a portion of the second printed material and at least a portion of the top label back surface to reduce friction between the base label and the rotating top label.

46. The method of claim 37, wherein the base label further comprises a first section positioned about an upper portion of the container, and a second section positioned about a lower portion of the container and coupled to the first section by a perforation.

47. (canceled)

48. (canceled)

49. (canceled)

50. (canceled)

51. (canceled)

52. The method of claim 46, wherein the perforation comprises at least a portion of a tamper evident feature.

53. The method of claim 46, wherein decoupling the base label first section from the second section and removing the first section from the container reveals a closure device on the container.

54. The method of claim 37, wherein the top label further comprises a first section positioned about an upper portion of the container, and a second section positioned about a lower portion of the container and coupled to the first section by a perforation.

55. The method of claim 54, wherein the perforation comprises at least a portion of a tamper evident feature.

56. The method of claim 54, wherein decoupling the top label first section from the second section and removing the first section from the container reveals a closure device on the container.
